(19) United States
(12) Patent Application Publication
(10) Pub. No.: US 2008/0047665 A1
(43) Pub. Date: Feb. 28, 2008

(54) Ceramic Arc Discharge Vessel and Method of Manufacture

(75) Inventors: Jeffrey T. Neil, North Reading, MA (US); Klaus Stockwald, Germering (DE); Victor E. Perez, Manchester, NH (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/467,270

(22) Filed: Aug. 25, 2006

(51) Int. Cl. B29C 65/00; H01J 17/16

(52) U.S. Cl. 156/296; 156/89.11; 156/304.2; 156/304.5; 313/634

(57) ABSTRACT

A method of forming a hollow ceramic body (10) comprising the steps of: forming a first section half (12) with a given wall thickness T and a second section half (14) with the given wall thickness T, the first section half and the second section half containing a binder material; forming a first joining surface (16) on the first section and forming a second joining surface (18) on the second section, the first joining surface 16 and the second joining surface 18 having a wall thickness T₁ thinner than the given thickness; simultaneously heating the first and second joining surfaces (16, 18) to cause localized melting of the binder material; initially contacting the first joining surface with the second joining surface to form an interface region; and applying compression to the interface region to join the first section (12) to the second section (14) without the protrusion of any material into a discharge space (20) formed when the first section (12) and the second section (14) are joined.

### TECHNICAL FIELD

This application relates to methods of joining ceramic components in their green state. In particular, this application relates to a method of thermally joining ceramic arc discharge vessel parts to form a unitary body for high intensity discharge (HID) lamps and to the arc discharge vessel so formed.

### BACKGROUND OF THE INVENTION

In general, commercial ceramic arc discharge vessels used in high intensity discharge (HID) lamps are comprised of a polycrystalline alumina ceramic, which may contain one or more additives to control grain growth. As a first step, alumina powder is mixed with a binder material such as a wax or thermoplastic and then formed into the desired shape by isostatic pressing, extrusion, or injection molding. The binder materials help the molded alumina piece retain its shape while the piece is in its “green state,” i.e., prior to binder removal and sintering. The binder is later removed when the pieces are fired.

Since the arc discharge vessels are fabricated from two or more pieces, it is necessary to form hermetic seals at the interfaces between the pieces, which hermetic seals are capable of withstanding the high stresses, temperatures and corrosive chemicals present in an operating arc discharge vessel. The conventional method of assembling ceramic arc discharge vessel pieces involves several assembly and pre-sintering steps in which the pieces are aligned and sealed together by means of interference fits. The interference fits result from the differential shrinkage of the pieces during firing. In each of the assembly and pre-sintering steps, there exists an opportunity for misalignment or other errors to occur. Minimizing the number of firing cycles can improve the efficiency of the arc discharge vessel production process. Furthermore, the practice of using interference fits to form the hermetic seals requires a high degree of control over dimensional tolerances and the shrinkage of the ceramic pieces during firing.

Several methods are available for solving the disadvantages enumerated above. One method, which is preferred, comprises joining two body halves in the green state. The method includes applying heat to the surfaces to be joined to cause a localized melting of the binder. The surfaces are then brought together and joined by applying compression. Another method is disclosed in U.S. Pat. No. 6,620,272 and comprises a method for making a ceramic body wherein the ceramic components are joined in their green state. The method includes applying heat to the surfaces to be joined to cause a localized melting of the binder. The surfaces are then brought together and joined by alternately applying compression and stretching. These methods are particularly advantageous for forming unitary ceramic arc discharge vessel bodies for high intensity discharge (HID) lighting applications; however, it has been found that these processes, while extremely efficient for ordinary ceramic arc discharge vessels, have disadvantages when employed in high efficiency ceramic metal halide lamps that use acoustically stabilized arcs. In such instances it has been discovered that the joining process of mating the two halves of the arc discharge vessel causes an intrusion of material into the discharge space that interferes with the acoustic stabilization of the arc.

### DETAILED DESCRIPTION OF THE INVENTION

It is, therefore, an object of the invention to obviate the disadvantages of the prior art.

It is another object of the invention to enhance arc discharge vessel operation.

It is yet another object of the invention to provide a two-piece arc discharge vessel that is suitable for use with an acoustically stabilized arc.

These objects are accomplished, in one aspect of the invention, by a method of forming a hollow ceramic body that comprises the steps of: forming a first section half with a given wall thickness T and a second section half with said given wall thickness T, the first section half and the second section half containing a binder material; forming a first joining surface on the first section and forming a second joining surface on the second section, the first joining surface and the second joining surface having a wall thickness T₁ thinner than the given thickness; simultaneously heating the first and second joining surfaces to cause localized melting of the binder material; initially contacting the first joining surface with the second joining surface to form an interface region; and applying compression to the interface region to join the first section to the second section without the protrusion of any material into a discharge space formed when the first section and the second section are joined.

Arc discharge vessels so formed have no unwanted intrusion of body material into the discharge space, thus providing a simple and economical method for fabricating arc discharge vessels to be used in systems requiring an acoustically stabilized arc.

### BRIEF DESCRIPTION OF THE DRAWINGS

FIG. 1 is an elevational view, partly in section, of an embodiment of the invention;

FIG. 2 is a similar view of a completed arc discharge vessel; and

FIG. 3 is an enlarged view of the joining edges.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

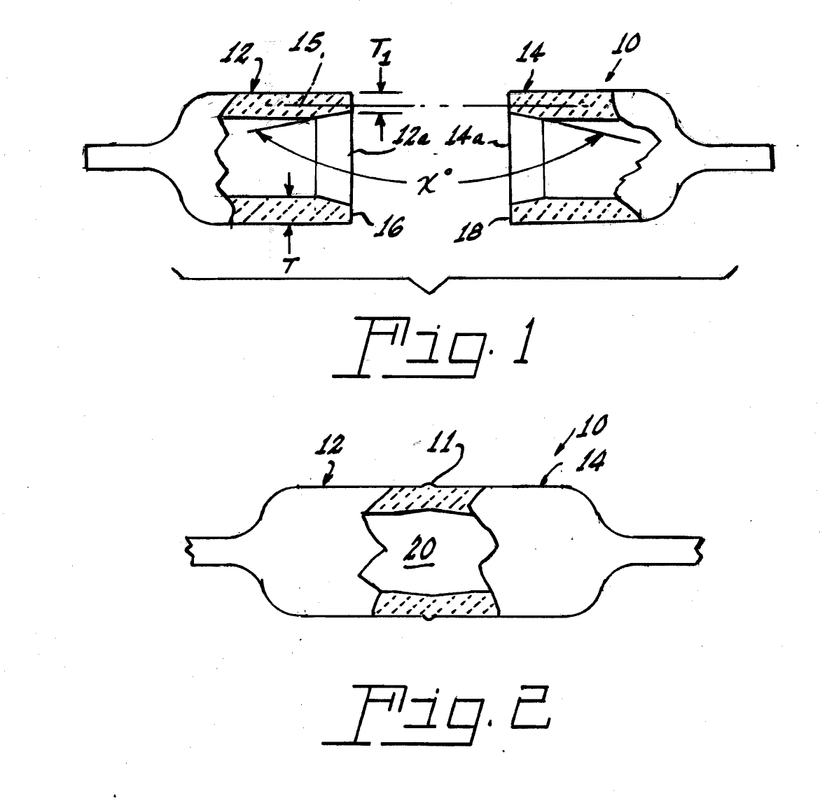

Referring now to the drawings with greater particularity, there is shown in FIG. 1 a two-piece hollow ceramic body 10 comprised of a first section half 12 and a second section half 14. Preferably, the two sections are axially symmetric and more preferably substantially identical in order to reduce the complexity and number of molds required for manufacturing.

The first and second sections 12, 14 have a wall thickness T formed about a centerline 15.

The first section 12 has an edge 12a formed as a first joining surface 16 and the second section 14 has an edge 14a formed as a second joining surface 18. The first joining surface 16 and the second joining surface 18 have a wall thickness T₁ that is thinner than the given thickness; the thinner wall thickness T₁ being formed by an internal taper. The tapers of the first and second sections form an angle X between them. Preferably, the angle X is between 171 to 174 degrees, inclusive.

In a preferred embodiment the wall thickness T is 0.8 mm and the wall thickness T₁ is between 0.65 mm and 0.75 mm. The taper extends for 1 mm from the edges 12a and 14a.

While the taper can be formed after the formation of section halves, ideally the taper is included in section half molds and is formed with the formation of the halves.

The first and second sections 12 and 14 are joined by simultaneously heating the first and second joining surfaces to cause localized melting of the binder material; initially contacting the first joining surface with the second joining surface to form an interface region; and applying compression to the interface region to join the first section to the second section without the protrusion of any material into a discharge space 20 formed when the first section and the second section are joined.

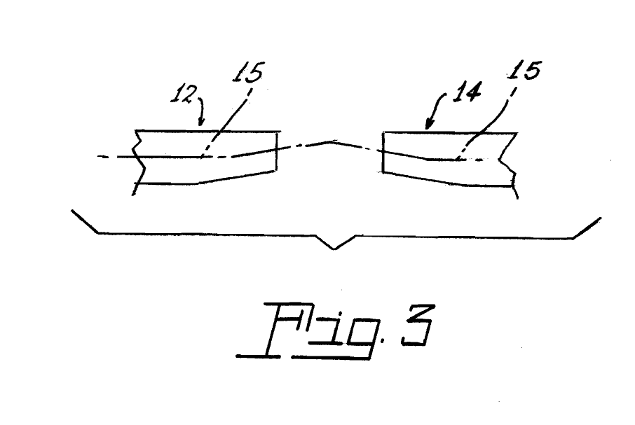

Preferably, the surfaces are heated by convection with a heated gas (e.g., forced hot air). Other methods of heating may include radiative heating by an infrared laser, an incandescent lamp, or an incandescent resistive element. In order to improve heating uniformity, the sections may be rotated about their axis while heating. Once the binder material at the surface has melted, the sections are quickly mated by contacting the joining surfaces and applying compression to the interface region. FIG. 2 shows the arc discharge vessel after the sections are thermally joined. A unitary arc discharge vessel body 10 is produced with a visible, external cosmetic seam 11 in the interface region between the two sections; however, no protrusion exists internally in the discharge space 20 as shown by subsequent analysis. Instead, an internal, centrally located groove extends circumferentially around the discharge space, said groove being preferably v-shaped in cross section.

The result was initially surprising since it was expected that the tapered region would act as a holding place for material displaced toward the inside of the arc discharge vessel during the joining process. It is now believed that the taper on the inside wall of the arc discharge vessel acts to cause all of the displaced material to move outward during joining. This effect is believed to be a result of the change in the direction of the centerlines of the arc discharge vessel thickness in the region near the join and is shown more clearly in FIG. 3.

In the initial testing the wall thickness was reduced by 0.15 mm, i.e., from 0.8 mm to 0.65 mm (an angle of 171°). After the initial results, to determine if the desired effect would occur with a lesser degree of taper near the joining plane, the taper was reduced to 0.05 mm, i.e., from 0.8 mm to 0.75 mm (an angle of 174°). Testing after the second design displayed the same configuration when the halves were joined together, lending support to the conclusion that the desired effect (no displacement of material to the interior of the arc discharge vessel) was achieved because of the change in direction of the centerlines.

When the arc discharge vessel body 10 is sintered, the resulting hermetic seal between the two sections is capable of withstanding the harsh environment of the operating arc discharge vessel. Although the external seam remains visible after the arc discharge vessel is sintered, it has been shown to have little or no adverse impact on the performance of the finished arc discharge vessel.

Accordingly, there is provided a method of producing ceramic arc discharge vessels that are suitable for use with lamps employing acoustically stabilized arcs.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A method of forming a hollow ceramic body comprising the steps of:
forming a first section half with a given wall thickness T and a second section half with said given wall thickness T, said first section half and said second section half containing a binder material;
forming a first joining surface on the first section and forming a second joining surface on the second section, said first joining surface and said second joining surface having a wall thickness T₁ thinner than said given thickness;
simultaneously heating said first and second joining surfaces to cause localized melting of the binder material;
initially contacting the first joining surface with the second joining surface to form an interface region; and
applying compression to the interface region to join the first section to the second section without the protrusion of any material into a discharge space formed when the first section and the second section are joined.

2. The method of claim 1 wherein the inside wall of said first section and the inside wall of said second section are tapered between T and T₁.

3. The method of claim 2 wherein said the inside wall of said first section and the inside wall of said second section are tapered for a distance of 1 mm.

4. A hollow, ceramic arc discharge vessel half comprising:
a section with a given wall thickness deployed about a longitudinal axis and terminating in an edge; and
a joining surface formed at said edge, said joining surface being thinner than said given thickness.

5. The hollow, ceramic arc tube half of claim 4 wherein said thinner joining surface is formed by tapering the inside surface of said hollow arc discharge vessel half.

6. A method of making a two-piece hollow ceramic body comprising the steps of:
forming a first section half with a given wall thickness T formed about a centerline and a second section half with said given wall thickness T formed about said centerline, the ceramic body containing a binder material;
forming a first joining surface on said first section and forming a second joining surface on said second section, said first joining surface and said second joining surface having a wall thickness T₁ thinner than said given thickness; said thinner wall thickness T₁ being formed by an internal taper, the internal taper of the first section and the internal taper of the second section having an angle X between them;
simultaneously heating said first and second joining surfaces to cause localized melting of the binder material;
initially contacting the first joining surface with the second joining surface to form an interface region; and
applying compression to the interface region to join the first section to the second section without the protrusion of any material into a discharge space formed when the first section and the second section are joined.

7. The method of making a two-piece hollow ceramic body according to claim 1 wherein angle X is between 171 to 174 degrees, inclusive.

8. An arc discharge vessel comprising a hollow ceramic body, the hollow ceramic body having a discharge space, the ceramic body having an internal, centrally located groove extending circumferentially around the discharge space.

9. The arc discharge vessel of claim 8 wherein the groove is v-shaped.

10. The arc discharge vessel of claim 8 wherein the groove is located at an interface where two sections of the hollow ceramic body have been joined.

11. The arc discharge vessel of claim 10 wherein the two sections are substantially identical.
